(19) United States
(12) Patent Application Publication
(10) Pub. No.: US 2017/0186019 A1
(43) Pub. Date: Jun. 29, 2017

(54) DETECTION AND REMEDIATION OF APPLICATION LEVEL USER EXPERIENCE ISSUES

(71) Applicant: InterDigital Technology Corporation, Wilmington, DE (US)

(72) Inventors: Shoshana LOEB, Philadelphia, PA (US); Kuo-Chu LEE, Princeton Junction, NJ (US)

(73) Assignee: InterDigital Technology Corporation, Wilmington, DE (US)

(21) Appl. No.: 15/325,381

(22) PCT Filed: Jul. 10, 2015
(86) PCT No.: PCT/US2015/039972

§ 371 Date: Jan. 10, 2017

Related U.S. Application Data
(60) Provisional application No. 62/022,850, filed on Jul. 10, 2014.

(51) Int. Cl. G06Q 30/00; G06Q 30/02

(52) U.S. Cl. CPC G06Q 30/016; G06Q 30/0201

(57) ABSTRACT

Detection and/or remediation of application user experience issues by detecting and/or correcting only network level QoS or QoE problems that affect user performance on a specific task or for a specific category of user, triggering remedial actions based on past experience of the effectiveness of the remedial action to a specific performance indicator, where the remedial actions may be sponsored by third parties, and/or providing remedial actions to maintain user performance and/or satisfaction beyond QoS parameter adjustment.

### CROSS REFERENCE TO RELATED APPLICATION

This application is the U.S. National Stage, under 35 U.S.C. §371, of International Application No. PCT/US2015/039972 filed Jul. 10, 2015, which claims the benefit of U.S. provisional application No. 62/022,850 filed Jul. 10, 2014, the content of which is hereby incorporated by reference herein.

### BACKGROUND

Maintaining an adequate level of service for online gaming and other applications may be relevant to attracting and retaining customers for these services. A difficulty in addressing this issue has been in defining measureable indicators that quantify level of service in a meaningful way and provide “adequate levels” for the various games and various players.

Methods have been proposed to address the problem of maintaining service level agreement (SLA) for networked services. For example, the issue has been proposed for network and cloud services using quality of experience (QoE) and quality of service (QoS) parameters as performance indicators. Calculation of QoE at per application flow basis has been proposed to provide feedback to the QoS adjustment mechanism.

While these efforts may provide various ways to improve QoE and SLA based on analysis of QoS data, they may not address or adequately address maintaining user task level performance and satisfaction for specific applications not included as performance indicators. Furthermore, proposed QoE calculation and QoS detection tasks may consume computing and network resources that may already be scarce and remedial actions that are derived may deviate from the normal configuration provisioned for the application traffic type as well as network configuration.

### SUMMARY

Methods, devices, and systems are described for detection and/or remediation of application user experience issues by detecting and/or correcting network level QoS or QoE problems that affect user performance only or preferentially on a specific task or for a specific category of user, triggering remedial actions based on past experience of the effectiveness of the remedial action to a specific performance indicator where the remedial actions may be sponsored by third parties, and/or providing remedial actions to maintain user performance and/or satisfaction beyond QoS parameter adjustment.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of an example communications system in which one or more disclosed embodiments may be implemented;

FIG. 2 is a block diagram illustrating an example system for improving quality of experience (QoE) and quality of service (QoS);

FIG. 3 is a flow chart illustrating example interactions with a credit earning task (CET) service;

FIG. 4 is a block diagram illustrating an example system for service data collection, analysis, and management;

FIG. 5 is a flow chart illustrating example operation of the example system of FIG. 4; and

FIG. 6 is a flow chart illustrating an example method according to aspects of the invention.

### DETAILED DESCRIPTION

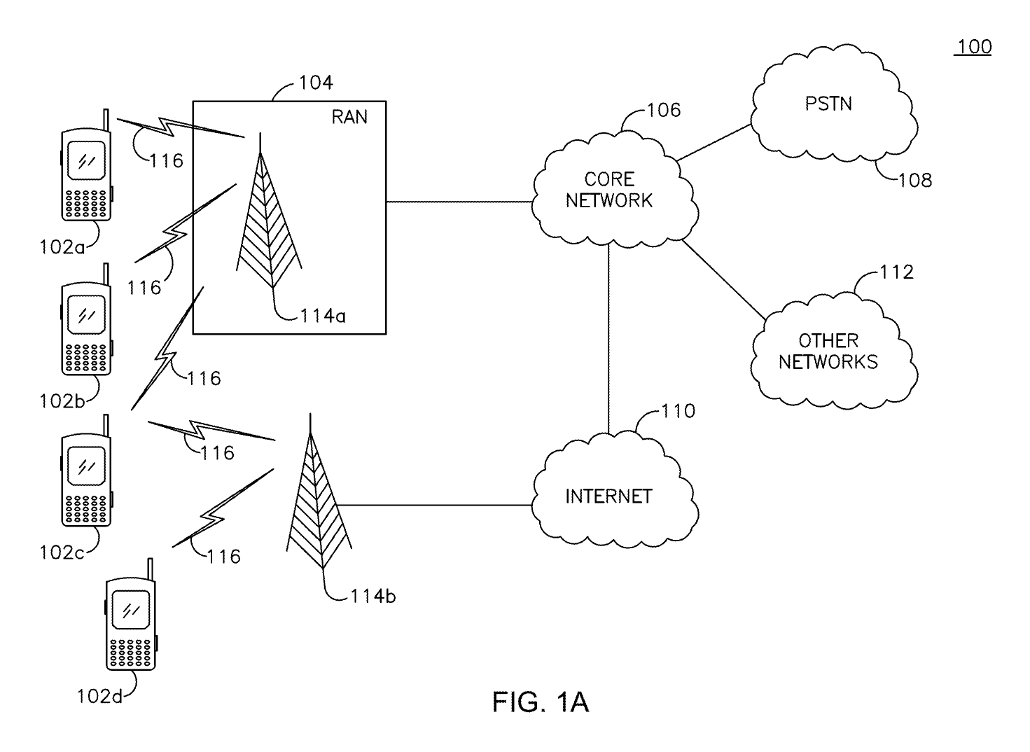

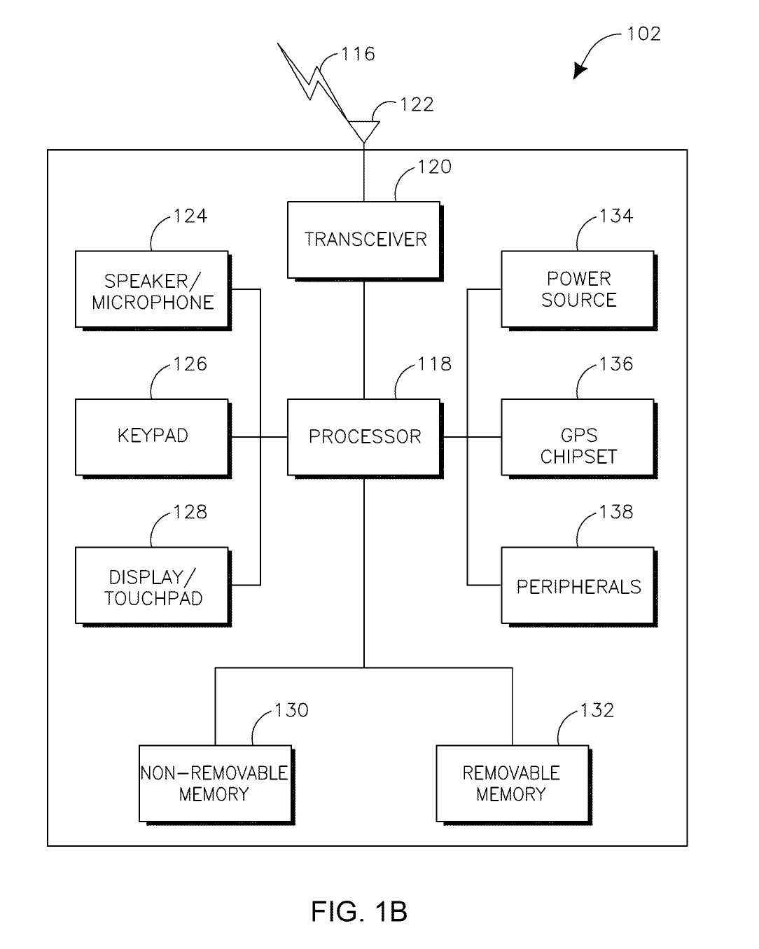

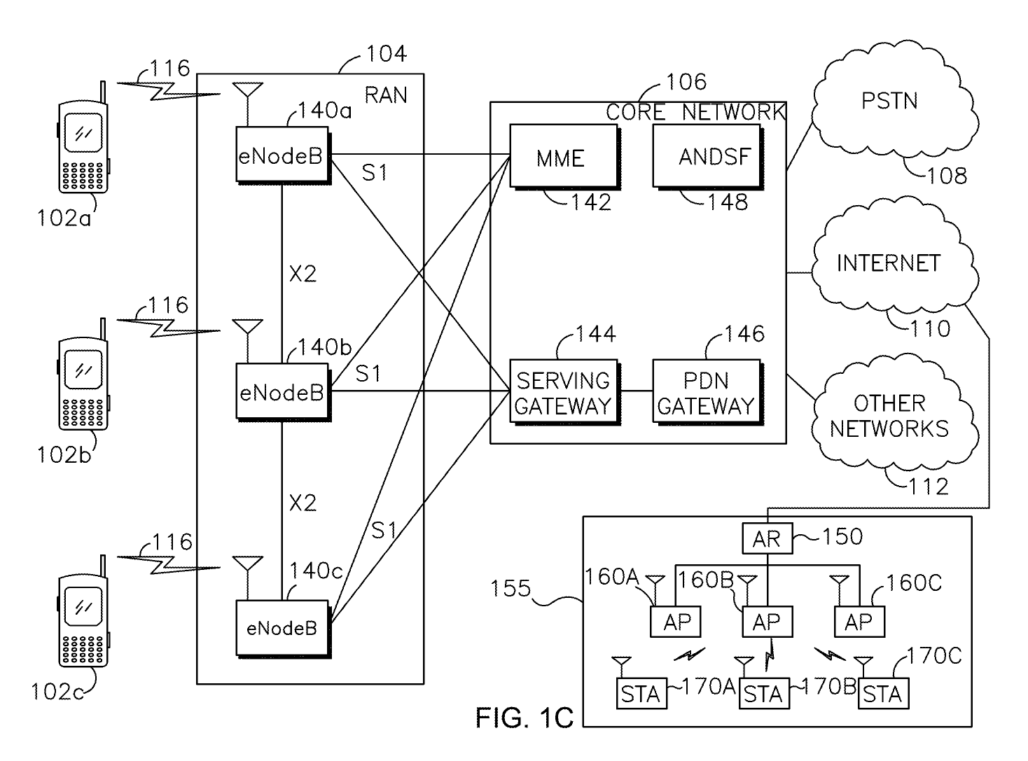

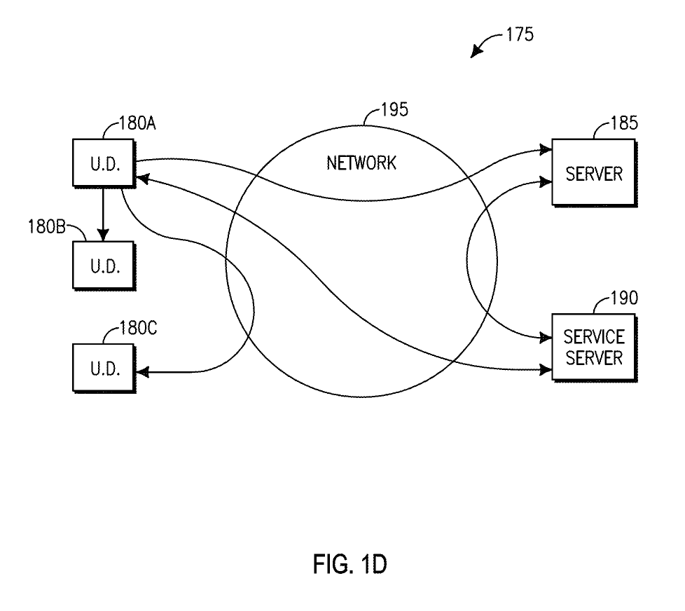

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C shows an example RAN 104 and an example core network 106 that may be used within the communications system 100 shown in FIG. 1A. As noted above, the RAN 104 may employ E-UTRA radio technology to communicate with the WTRUs 102a, 102b, 102c over the air interface 116.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices. An access router (AR) 150 of a wireless local area network (WLAN) 155 may be in communication with the Internet 110. The AR 150 may facilitate communications between APs 160a, 160b, and 160c. The APs 160a, 160b, and 160c may be in communication with STAs 170a, 170b, and 170c.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 1D is a system diagram of an example communications system 175 in which one or more disclosed embodiments may be implemented. In some embodiments, communications system 175 may be implemented using all or a portion of system 100 as shown and described with respect to FIG. 1A.

User device 180a, server 185, and/or service server 190 may communicate over communications network 195. These communications may be wireless, wired, or any combination of wireless and wired. Communications network 195 may include the internet 110, core network 106, other networks 112, or any other suitable communications network or combination of communications networks.

User device 180a may include a WTRU (such as WTRU 102a), or any suitable user computing and/or communications device such as a desktop computer, web appliance, interactive television (ITV) device, gaming console (such as Microsoft XBOX™ or Sony Playstation™) or the like. User device 180a and/or applications executing on user device 180a may generate events such as mouse clicks, keyboard strokes, and the like. These events may be processed by user device 180a and/or may be transmitted to another device such as server 185 or service server 190.

Server 185 may include a web server, application server, data server, or any combination of these or other types of servers. Server 185 may include any suitable server device such as a server computer, personal computer, or the like. Server 160 may host applications accessible to user device 185a. For example, server 185 may include a gaming server hosting a massively multiplayer online game (MMOG), an email server, a web server hosting a website such as a social media website or blog, or other types of servers typically accessible by a user device over a computer communications network.

User device 180a may access server 185 over computer communications network 175 to interact with services that it provides. For example, user device 180a may access a game server hosted on server 185 to participate in a multiplayer online game. Access of server 185 by user device 180a may be via a client application executing on user device 180a or any other suitable mechanism. In some cases, the server may receive events from the user device, or may send events to the user device. For example, the server 185 may send an event to user device 180a indicating that additional in-game resources are required for continued play.

Service server 190 may include a web server, application server, data server, or any combination of these or other types of servers hosted on a server device. Service server 190 may include any suitable server device such as a server computer, personal computer, or the like. Service server 190 may be configured to communicate with server 185, for example, over network 195 or any other suitable communications medium. Service server may be co-located with, combined with, or in direct communication with server 185.

Service server 190 may communicate with server 185 to provide services, such as third party services, to users of server 185. For example, a subscriber to a game hosted on server 185 may access server 185 from user device 180A and may subscribe to third party services for the game which are hosted on service server 190.

Service server 190 may be configured to receive and/or intercept events transmitted between user device 180a and server 185. For example, in some embodiments server 185 and service server 190 may be configured such that server 185 may send an event destined for user device 180a instead or additionally to service server 190, and service server 190 may send the event or another event, signal, or message to device 180a. For instance, in a case where server 185 includes a game server, server 185 may send an event to service server 190 indicating that a user of user device 180a requires additional in-game resources for continued play, and server 190 may send the event or another signal or message to device 180a indicating that a CET is available to acquire additional in-game resources, and may provide a CET to the user. In some embodiments, service server 190 may only forward the event to device 180a under certain conditions, such as based on a user preference and/or context information relating to the user of device 180a.

In some embodiments, the functions of service server 190 and server 185 may be implemented using the same device, or across a number of additional devices.

In some embodiments, user devices 180b and 180c may communicate with server 185 and/or service server 190 via user device 180a. For example, user device 180a may forward a notification message from service server 190 to user device 180b via a peer to peer connection and may forward a notification message from service server 190 to user device 180c via network 195. In some embodiments, user devices 180a, 180b, and 180c may form a network, such as a peer-to-peer network, and such network may have a mesh topology, a star topology using user device 180a as a coordinating node, or any other suitable topology. In such embodiments, the peer-to-peer network may operate independently of server 185 and/or service server 190, and may incorporate functionality that otherwise would be hosted by server 185 and/or service server 190, such as functionality described herein.

Detection and analysis of user level key performance indicators associated with a specific task performed by a specific user application (e.g., gaming applications) may provide customer satisfaction and retention while reducing the overhead of network QoS impairment detection.

User performance and satisfaction may be maintained and/or improved by detecting and/or analyzing a set of user level key performance indicators (UKPIs) associated with a specific task performed by a specific user application. When detecting abnormal trends from these user performance indicators, remedial operations may be triggered, including network QoE and QoS detection and adjustment actions.

Furthermore, methods and devices described herein may support customer retention operations on a focused group of customers (VIP) and/or certain types of network problems, which may reduce the resources needed for monitoring as compared to monitoring all customers and/or all types of problems. For example, a set of VIP customers (e.g., 10% of customers) may be dynamically selected based on business rules such as monthly revenue. One time or periodic network monitoring of network delays may be performed only when detecting a degradation of a selected set of user level performance indicators or when receiving a specific user complaint for example.

Such methods and devices may have the advantage of avoiding wasted efforts in detecting and/or fixing network level QoS and QoE problems that may not affect user performance on a specific task; triggering remedial actions based on past experience of the effectiveness of the remedial action to a specific performance indicator; enabling a user (or player) to earn credits from third party sponsors to improve performance of a current task; and/or providing immediate and multiple types of remedial actions to maintain user performance and satisfaction in real-time beyond the QoS parameter adjustment.

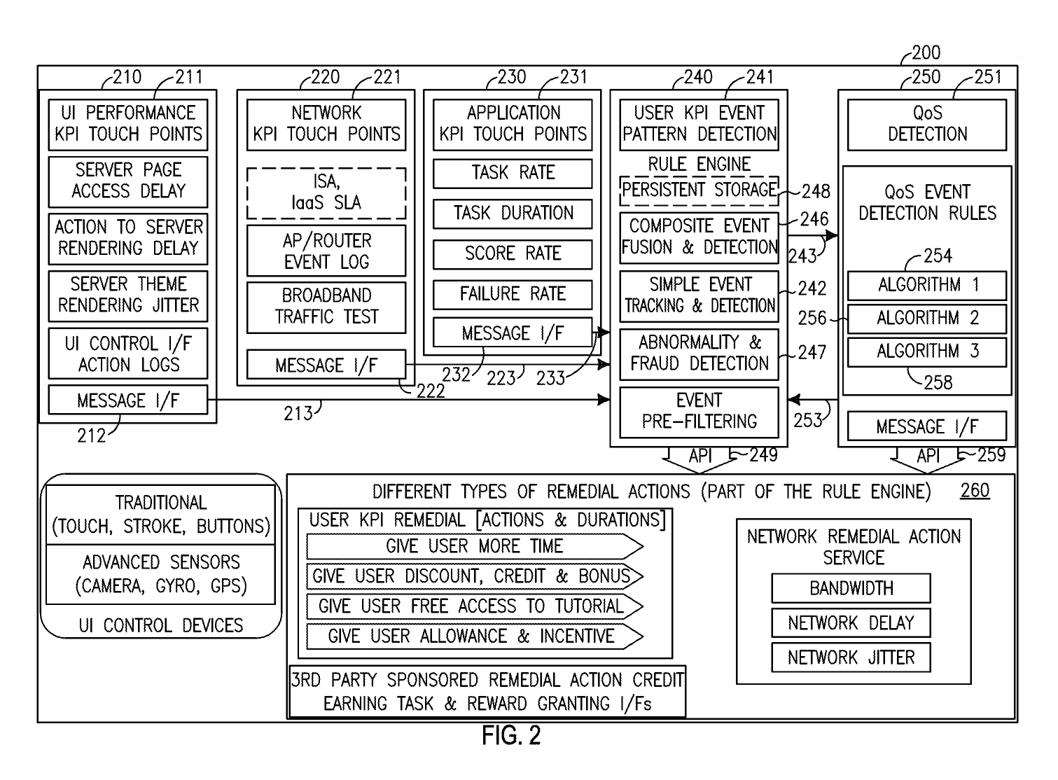

FIG. 2 illustrates an example system 200 which includes a user interface performance indicator collector 210, a network data performance indicator collector 220, a user application data performance indicator collector 230, User Key Performance Indicator (UKPI) event pattern detection rule engine 240, a QoS detection module 250, and a remedial action firing module 260. The system may provide remedial action for player retention, which may be automated. It is noted that while system 200 is described has having various functions organized into particular modules, those having skill in the art will understand that various implementations may organize such functions into different modules or combinations of modules, and may omit or add functions. System 200 may be implemented, for example, using any suitable computing device or devices and/or computer communication network, for example, service server 180 as described with respect to FIG. 1D.

The data collectors 210, 220, 230 may include a set of data collection touch points 211, 221, 231 instrumented with a set of data collection software development kits (SDKs) and/or application programming interfaces (API) for user interface (UI), network, and/or server applications. Data collectors 210, 220, 230, 250 may include message interfaces 212, 222, 232, 252. The message interfaces 212, 222, 232, 252 in the different data collectors 210, 220, 230, 250 may use an API (which may be a common API) to communicate event messages 213, 223, 233, 243, 253. Event messages 213, 223, 233, 243, 253 may include, for example, game metric data as well as other network and user events. The event messages may be based on a tag-value pair format. For example, game metric data, e.g., as transmitted by user application data collector 230, may be of the following format: {playtime: 5 min, win-rate: 70%, achievement-levels: 7, and Scores: 2000}.

Additional attributes such as event-types, subtypes, time, IDs corresponding to the game metric data may be added to support statistical analysis and reports on subsets of data for different games. The tags may be parsed and filtered by an event pre-filtering module 245 in the event pattern detection engine 240.

The event pre-filtering module 245 may filter out event messages if the tags in the event message are not used by any rules in the event pattern detection engine. The network events may include a message which may have the following example format: {AvgRoundTripTime: 200 (ms), Time: 11:00 pm-11:30 pm}. The user events may include the following example format: {NickName: Knight212, Connect: 6/27/2014 11:20 pm} or {NickName:Knight212, Disconnect: 6/27/2014 11:30 pm}.

The message interfaces 212, 222, 232, 242 may be adapted to different remote communication formats. One example interface may include a RESTful (Representational State Transfer) API having a XML/JSON (Extensible Markup Language/JavaScript Object Notation) format. It may also use a Cloud-specific message queue service if the data collector and the event pattern detection engine are in the same Cloud.

UI related collectors, such as user interface performance indicator collection module 210, may be located in a local client machine such as user device 180a, for example. Such UI related collectors may be located in a local client machine for example where the application is downloaded and run on the client machine only. UI related collectors may also or instead be located in a server such as server 185 or service server 190, for example, if the application is hosted in the Cloud. The network data and application server (game server) data collectors may run in the Cloud, for example, on a server such as server 185 or service server 190. However, if the game engine is running in a peer-to-peer mode, application server related data collection may be performed in a designated client machine that hosts the game for the rest of the players (e.g., one of user devices 180a, 180b, or 180c). The UKPI event pattern detection engine 240 may include UKPIs 241, a simple event tracking and detection module 242, a composite event fusion and detection module 246, and an abnormality or fraud detection module 247. Each module may contain groups of rules supporting KPIs from different games. The rules in each module may process UKPI data streams from multiple collectors (such as 210, 220, 230, 250), perform statistical data analysis (e.g., moving average) on collected data and/or detect abnormal trends in the collected data.

The resulting statistical data for each game may be modeled as time series vectors, cached in a memory, and/or stored in a persistent repository 248 for secure and/or fast accesses by groups of processing rules for the same game. To support multiple types of game data, the rules may be divided into groups for each game.

The tag definitions for each game may be defined by the game developer of each game and may be made accessible to the processing rules. The rules may be defined by game developers for each game, as each game may have a different definition of win/loss and/or other user behaviors for example. Multiple games may have a set of common default rule samples. For example, the playtime statistics of a user or a group of users may be independent of the specific type of game.

UKPI event pattern detection engine 240 may be located in the Cloud, for example, on a server such as server 185 or service server 190. UKPI event pattern detection engine 240 may include a set of RESTful APIs with tag-value pairs encoded in JSON or XML format. UKPI event pattern detection engine 240 may also take inputs from a Cloud specific message queue service.

A customer retention service, for example, system 200 or as implemented using system 200 or portions of system 200, may provide methods or facilities for game developers to edit, build and load rules into UKPI event pattern detection engine 240. A declarative rule table editor or Domain Specific Language (DSL) may be used by game developers to edit the rules. The event processing and condition matching function may be implemented by UKPI event pattern detection engine 240.

Game developers may be permitted or facilitated to write and/or execute condition evaluation and actions rule scripts in UKPI event pattern detection engine 240. UKPI event pattern detection engine 240 may decode the event messages from data collectors 210, 220, 230, 250 and may dispatch the contents of the events to different groups of rule scripts based on, for example, GameID, event type, subtype, and/or other parameters. These rule scripts may be programmed by game developers and inserted, for example, as server code UKPI event pattern detection engine 240.

If a performance degradation trend is detected, UKPI event pattern detection engine 240 may trigger a simple event tracking and detection module 242 or composite events fusion and detection module 246 to invoke suitable remedial actions that are effective to maintain user performance and satisfaction levels for the specific task. A user may also be provided with a notification of network problems in real-time. A remedial action may also be implemented by rules executed by a rule engine to support dynamic management of remedial actions.

The UKPI event pattern detection engine 240 may invoke network QoS detection module 250 and/or remedial action module 260 where abnormal UKPI trends from application tasks or user interface control tasks are detected (e.g., by analyzing event messages 213, 223, 233, 243, 253). Network QoS detection may not be invoked where abnormal UKPI trends are not detected. This may have the advantage of avoiding undue system overhead in situations where network QoS issues, while present, do not affect user experience.

For example, if the network has transient delay, packet loss or jitter, QoS detection and adjustment actions may not be invoked by the UKPI engine unless an observable degradation of UKPI of user tasks is detected. However, if a UKPI trend is detected which is identified as having historically impacted QoS, a QoS remedial action may be launched. The user may also receive a notification of the network problem. QoS event detection module 250 may include one or more QoS event detection algorithms 254, 256, 258.

User interface (UI) and network data may be monitored and/or collected in-client (e.g., in user device 180), locally in the game server (e.g., server 185), or potentially in a third party service server (e.g., service server 190).

In some implementations, only those key performance indicators (KPIs) representing a summary of user and network behaviors may be sent as event messages to UKPI event pattern detection engine 240. This may be advantageous in implementations where UKPI event pattern detection engine is implemented remotely, such as where UKPI event detection engine 240 is located in service server 190 and the UI and network data are monitored locally in user device 185a or server 185.

This approach may avoid some of the communications overhead of collecting low level data from a large number of devices (e.g., a plurality of clients such as user devices 180A, 180B, 180C) and CPU overhead of calculating KPI events in UKPI event pattern detection engine 240.

In some implementations, QoS may be detected only for VIP users and/or only when problematic UKPIs (e.g., poor average win/loss rate, playtime, quit time, kill rate, and so forth) are detected. This approach may also have the advantage of reducing CPU and/or network overhead.

Both the UKPI event pattern detection engine 240 and the QoS detection engine 250 subsystems may call an API or APIs provided by the network remedial action service. For example, detection engines 240 and 250 may call APIs 249 and 259 respectively to invoke remedial action firing module 260. The network remedial action service may provide remedial actions for network impairments (e.g., jitter, delay, disconnect, and so forth) including sending messages to a network service provider and/or notifications to users. These remedial actions may also include monetization-related actions such as providing a network upgrade promotion code to the player, and may have the effect of improving the player's service experience by using multiple types of remedial actions even if the network impairment may not be fixed immediately.

Example QoS event detection algorithms 254, 256, 258 include generating and sampling traffic statistics corresponding to the specific class of services and priorities associated with application modules impacting the user UKPI. QoS event detection algorithms 254, 256, 258 may also monitor and collect selected QoS parameters for selected VIP players before and/or during the game. If KPI degradation or a serious QoS issue is identified, the QoS detection rules may generate one or more network remedial action recommendations based on the results of the QoS detection.

In addition to KPI, rules may be included to detect a “game start event message” and launch a QoS detection operation to check if the network meets the minimal requirements on delay and/or bandwidth for the game. If the network connection does not meet the requirements and no network level remedial actions are implemented, a suggestion for a different game server and/or one or more other remedial actions such as a promotional reward and/or network upgrade credits may be provided to the customer.

UKPI event pattern detection engine 240 may implement various types of algorithms using rules. The system may detect KPI degradation and provide advance warning in real-time based on rules which may be defined by game developers. For example, simple event tracking and detection module 242 may track and record the history pattern of a KPI (e.g., win/loss rate or hit rate) collected from multiple plays of a player at different times. The history pattern may be stored in persistent storage 248. The acquired history data may be used to detect abnormal trends of KPI in real-time. Abnormality and fraud detection module 247 may compare real-time input KPI data against the recorded history to determine whether it falls below a preset threshold. For example, abnormality and fraud detection module 247 may detect whether a given KPI falls below a historical average for 3 consecutive observations. If such degradation is detected, an early warning type of remedial action may be triggered to notify the player and/or invoke QoS detection operations.

Detection and analysis of UKPI event patterns may include collecting and recording player game data as historical data; calculating a statistical distribution of the game data; collecting real-time game data; pre-filtering the real-time game data for relevant events; calculating a running average of the game data for a specified time window; tracking the running average over time and generating win/loss rate events at defined intervals; calculating and accumulating the number of times the game data falls below a threshold; and inputting the detected number of below-threshold events to a specific rule set. The process may continue for each new collected real-time game data.

Collected and recorded game data may include, for example, a win/loss rate of a level of a game. Statistical distribution of the game data may include, for example, an average, standard deviation, or other suitable statistical model of the game data for a particular period of time. The historical data and/or statistical distribution may be made available to a rule engine, such as by writing to a rule-engine accessible variable or memory location. Collection of real-time data may include, for example collection of win/loss events. Pre-filtering of the real-time data may include deleting events that are not of interest or for which no active rules are defined. Calculation of the running average may be over a specified time interval or moving window such as per day, week, or month. Calculation and accumulation of the number of times the game data falls below a threshold may include detecting the number of times a win/loss rate falls below a predefined threshold and generation of a “below threshold” event.

An example rule set to which the below-threshold events (or number thereof) may be input may include simple event detection rules, multiple event detection rules, and/or mixed event detection rules. An example simple event detection rule would be to trigger a remedial action if a below-threshold event indicating a loss rate greater than 90% is received. An example multiple event detection rule would be to trigger a remedial action if three below-threshold events are received, or if three below-threshold events are received in consecutive observations.

An example mixed event detection rule would be to check for network delays or other problems if three below-threshold events are received in consecutive observations, and depending upon the result triggering different remedial actions. For example, the user could be notified of network delays and provided with a network upgrade promotion if there are network delays, or may be provided with a tutorial or a discount for a new shield, weapon, or other in-game item if there are no network delays.

The example above illustrates one of many possible programmable detection methods, as will be evident to those having skill in the art, which may be implemented using system 200. There may be variations on the window size of the moving average, statistical distribution or decision tree models, number of predictive steps, or on the fly processing for example.

Example pseudo code for a rule written by game developer using multiple KPIs, such as AvgWinRate, AvgRoundTripTime, and AvgShootingAccuracy (defined as average number of shot fired/number of target hit in a half hour time window), may be defined as shown below:

Declare KPI event type pseudo code:

declare KPIEvents
... definetype as ( event )
datetime : java.util.Date
GameID: String
PlayerID: String
KPIType: String // UserBehavior | NetworkBehavior
KPIID : String // AvgWinRate | AvgShootingAccuracy | others
Value1 : double //e.g., average value over the moving window.
... Value2 [ ] : Double //Other stats such as std, min, max...
MovingWindow : INT //e.g., 1800 sec window
End
... other KPI declarations...

Rule declaration pseudo code:

Rule Name: “RetentionAlertRule1”
...Define rule group... //Game 1 KPI rule group
...Declare GameID's property, PlayerID's property and KPI objects and

| | |
|---|---|
| bindings | //Game, user and KPI object binding (e.g., facts and |

global variables)
...Declare KPI event stream

//AvgRoundTripTime, AvgWinRate, and AvgShootingAccuracy in

event stream

If (And (And (AvgShootingAccuracy < 50%)

(AvgWinRate < 30%))
(PlayerID.status == VIP)
(AvgRoundTripTime > 400 ms))

Then

...Get the promotion coupon code and prepare an email message
...mailto:PlayerID.email
//Remedial action: Send network upgrade promotion

The above example may be coded as a rule using an editor provided by a rule engine. The order of execution of the different components of the “if” part of the rule may be determined by built-in or dynamic optimization policies such as “first check if the user is a VIP and then check other for other conditions about his gaming behavior”. Under such policy, the rule may be executed only for players that are VIP. Such rule may also be implemented as a script to be executed when an average shooting rate KPI event is received by the event pattern detection engine or in other ways.

Various types of event and condition parameters and choices of remedial actions may be programmable for different use cases. For example, data may be collected and models built for overall level of play of the user, motivation for playing, temperament of play, amount of money the user usually spends and under what circumstances, user context, or user performance.

Overall level of play may include a level of mastery of the user, i.e., whether they are a master or a novice level player. Motivations for playing may include winning, social interaction, or experience. Temperament of play may include speed or other conditions. For example, temperament may indicate aggressive or slow play. The amount of money the user spends may be real money or some substitute for money, such as credits, in-game gold pieces, and so forth which are usable in a specific game. User context may include a location from which the user usually plays, such as home or school, a device used or usually used by the user when playing from a particular location. For example, a user may usually use a tablet on the bus, or a PC at home. User context may also include an amount of time the user usually plays or usually plays in the various locations using the various devices, or other correlations regarding user location, device, and/or in-game behaviors. User performance may be in the context of the user's past performance or in relation to other players or similar players. User performance may be measured, for example, as a number of times the user failed to acquire a game resource or score that the user or another user would normally succeed in acquiring/attaining, an amount of time taken to complete a quest, level, or other task within a game beyond that normally taken by another user with similar experience, or the user's efficiency in using game resources. User efficiency may be calculated for example by comparing the efficiency of a path taken by the user within a game world to accomplish a task with the efficiency of paths taken by other or comparable users.

### Remedial Actions

Based on a predicted abnormality trend, one or more event and/or condition detection rules may be invoked, which in turn may execute one or more remedial actions. Remedial actions may include detection and/or adjustment of network QoE and/or QoS parameters; providing the user with virtual resources; or enabling the user to earn credits from tasks offered by third parties.

QoE and/or QoS related remedial actions may include increasing the user's priority, class of service, or available CPU resources. Virtual resources provided to the user may include a postponed deadline, increased number of allowable attempts, discounts, credits, bonuses, items useable within the game (e.g., upgraded armor, ammunition, health) and free tutorials or hints. Credit-earning tasks provided by third parties may include pop quizzes, a short essay followed by a quiz, market surveys, a homework assignment or part of a homework assignment, or a simulation or practice of a task.

Such remedial actions may be selected based on a measurement of their effectiveness as learned from previous experiences recorded in the system and encoded as events, conditions, and action rules for specific users and/or specific tasks.

For example, some tasks may be known to be highly dependent upon QoS parameters (e.g., voice or video streaming). Adjusting priority and class of service for the application temporarily or for a specific duration then may sufficiently solve a temporary QoS issue. Some other types of tasks, on the other hand, may depend upon a users' skill or concentration level. Adjusting QoS for such tasks may have minimal impact to the user.

Methods and devices described herein may have the advantage of reduced overhead as compared to monitoring all players. For example, initially VIPs may be selected from either an existing list and/or by detecting monthly revenue as KPI. Once a user is identified as VIP, more detection rules associated with KPI parameters may be activated for the VIP user (e.g., for all VIP-classified users) which may provide better customer service experiences.

Furthermore, by applying combinations of event pattern detection rules based on user behavior context summarized by KPIs, the system may also provide “pertinent” and/or “in the moment” remedial actions to the VIP. For example, when detecting a VIP taking a longer than average time to pass a game level, an on-line tutorial or help may be offered to the VIP.

### Multiple Time Scales

Abnormal behavior may be detected in different time scales. For example, a user may normally complete 4 tasks from an application (e.g., game, or customer services) per minute and/or score 200 points per hour on average. However, due to background application overhead (e.g., software download, archiving, anti-virus checks or other scanning processes) or additional workload (e.g., advertising or app updates) for example, the task completion rate (e.g., number of tasks completed per minute or per hour) may drop below or a certain amount below the average or other threshold. In that case, QoS detection may be activated and an appropriate remedial action or actions (e.g., provide more shield or points) may be determined. Such remedial actions may be invoked for a specific time period (e.g., for 5 minutes, 1 hour, or 5 hours). A remedial action may be applied based on a time period in proportion to the corresponding time scale over which the abnormal behavior is detected (e.g., minutes or hours).

### Third Party Sponsored Remedial Actions

A category of remedial actions may be employed to support a user (e.g., a video game player) to earn reward credits, or other relevant remedial measures, sponsored by third parties, for example, parents or non-profit organizations who may be concerned about the wellbeing of the player and who may be willing to pay for the remedial actions.

In contrast with parental control of access and time allocation of application tasks, third party sponsored credit earning tasks may enable parents or other third parties to channel motivation and incentive generated by a game or other application to tasks beneficial to the user or player.

In contrast with an advertising network where ads are selected and paid for from a pool of advertisers based on the context of a user's web or in-game activities, credit earning tasks may be pre-selected and/or prescribed by a parent, educator, or other third party for specific needs of a specific user.

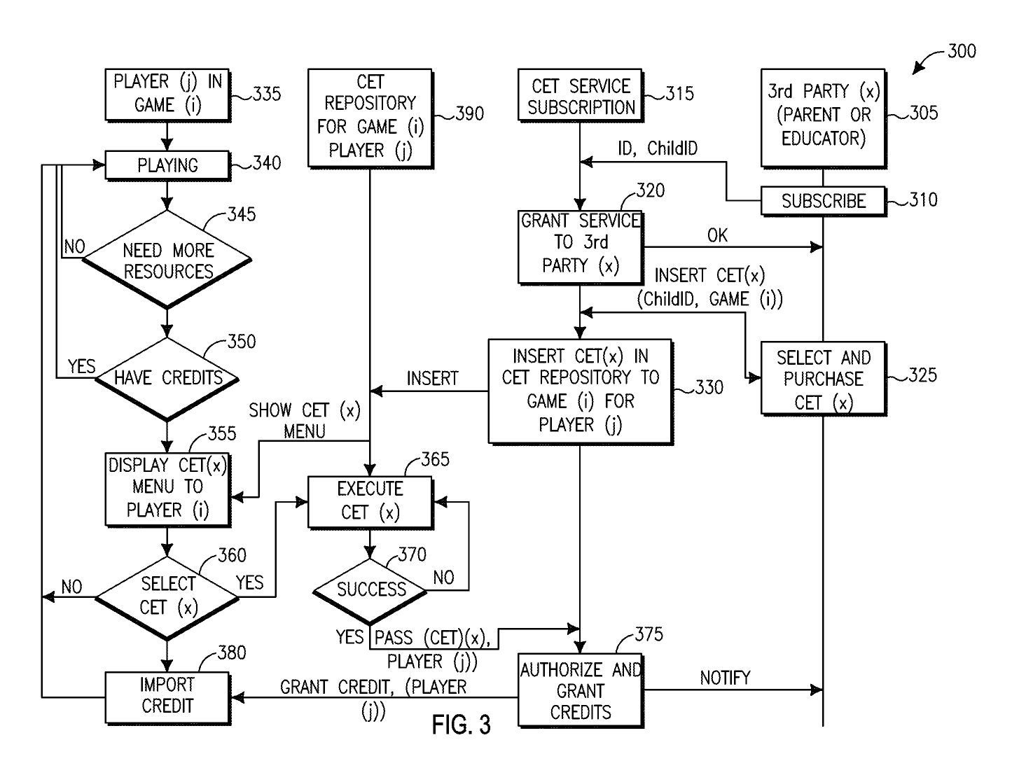

As shown in FIG. 3, the operation and monetization work flow may be controlled by the third party, such as a parent, and not by the advertiser. The CET may be specific to needs of a specific child or other user.

A remedial action may be implemented as an external task. Upon completion of a third party sponsored task, the player may earn “Credits” from “Tasks” previously purchased by the third party sponsor. CETs may be designed by independent developers or service providers. A service provider may offer a CET advertising and/or recommendation service to third party sponsors for different applications (e.g., games), as value added services. Third party sponsors then may purchase one or more suitable CETs for a specific user or users based on an understanding of the knowledge and education level of the user (e.g., player) which may make CETs inside the application more interesting and relevant to the user.

An open CET service interface work flow 300 is described for multiple games and CET developers. As shown in FIG. 3, third party sponsor(s) 305 may subscribe in step 310 to the CET service 315. CET service 315 may provide access and a selection of CETs to third party sponsor(s) 305 in step 320. The CET service 315 may provide recommendations of CETs for purchase to third party sponsor(s) 305. Third party sponsor(s) 305 may select and purchase CETs provided by the CET service in step 325, and the CET service 315 may insert the purchased CET(s) into a game repository 390 for player 335 in step 330. Each CET may have a credit unit that is associated with a virtual currency, in-game resources, or other types of rewards. Third party sponsors may deposit credits and select the CETs suitable for a specific player.

In the heat of the game or at other critical moments, a player 335 may need more resources to accomplish in-game objectives for example. Thus if player 335 is playing a game 340, on a condition 345 that player 335 needs more resources and on a condition 350 that player 335 does not have credits or other means to obtain these resources, the UKPI event pattern detection engine 240 may detect this situation based on the degrading UKPIs in the game or user action for example and may trigger an in-game recommendation 355 of appropriate CETs to the player. On a condition 360 that the player chooses to invoke a CET or CETs, the player's activities may be paused or suspended in invisible mode, or replaced by a Game Bot for example. In step 365 the player may be prompted and/or guided to win resources such as credits by completing the CETs. On a condition 370 that the player completes the CET(s), the credits or other resources earned may be certified and granted by the CET service (and third party sponsor(s) 305 may be notified) in a step 375 before being traded and/or imported into the game in step 380 as in-game resources. In some implementations, CETs may be re-played to reconfirm the credit earned.

CETs may have different execution lengths and/or complexities which may match or otherwise correspond to a context of the game and/or experience of the player. Example CETs may include quizzes, simulations, exercises, or surveys. Example quizzes may include a short reading quiz related to homework, such as physics or math questions. The quizzes may be available to be taken for full credit or for partial credit with hints.

Example simulations may include a separate educational simulation game which may run in parallel with the main program. Simulation level proficiency may be related with casual game experience level (i.e. experience level in the main game). Example exercises may include question and answer format quizzes for historical causality events. Example surveys may include academic or market research surveys.

Benefits of providing CETs may include providing new opportunities for educators and parents to help children to learn and to test progress using educational CETs created by an educational game developer community; providing a quality and information rich context to help students to learn new subjects graphically and/or interactively; providing a monetary incentive to CET developers, service providers, and players; enabling a third party (e.g., parents, social workers and educators) to engage in both gaming content and CETs; enabling sponsored in-app advertisements or surveys during the execution of a CET (such CETs may also support educational products advertisements to generate additional revenue); enabling nesting and/or mixing of parallel execution CETs with surveys or advertisements; and enabling censorship and/or allocation of advertisements using a framework provided for censorship and/or review of the CETs.

Various combinations of CET service models may be supported by expanding the number of third party sponsors, users (game or application users), and/or conditions to enable credit earning tasks for the users while playing or working. For example, one or more organizations may sponsor CETs for a group of users in a special program or grade level for one or more selected game titles. As another example, a corporate trainer may insert CETs into interactive training applications or business workflow routing. If it is detected that a worker is having difficulty passing a training subject or has no on-going task assignment from the workflow, CETs may provide encouragement to the worker to make extra efforts to learn how to pass the subject test and/or earn bonus credits toward purchasing company products for example.

It is noted that these extensions may be based on the same architecture, workflow and monetization model. Third party sponsors may pre-screen, select and/or purchase CETs for a specific set of users to choose of CETs having content that is suitable for the user and/or is noncommercial (e.g., no ads). The players/users may receive credit only by successful completion of the CET. CET service providers may sell CETs to sponsors, paid credits to players/users and/or paid game developers for inserting the CETs. Game developers may authorize and/or grant credit earned by the users.

### VIP Personal Profile Builder

In addition to automated in-app data collection, a proactive real-time VIP personal profile builder may enable VIP users to directly declare and/or demand preferential treatment, provide feedback (e.g., suggestions beyond typical impressions), and/or report problems in the application (i.e., in-app). The profile builder may collect the VIP inputs by providing predefined forms that are related to the context of the game. VIP players may select the forms to provide direct input immediately and/or without requiring the user to search and launch separate forms to report problems and/or explain when and under what context, the problem or problems occur. Furthermore, to create a context aware “in the moment” personalized service, remedial actions may be provided to the VIP user in real-time in response to the user's inputs.

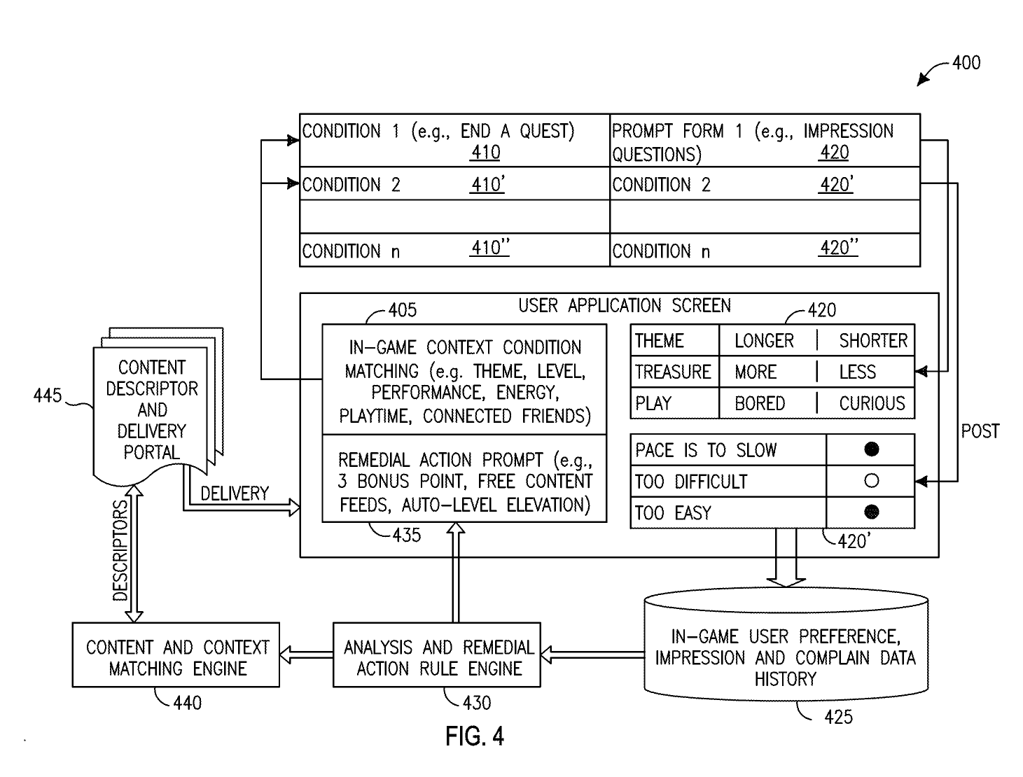

FIG. 4 illustrates an example system 400 for application context analysis and player profile building. In FIG. 4, application context 405 (e.g., theme, game level or score) may be monitored and matched with conditions 410, 410′, 410″ in a form selection table 415. This monitoring and matching may be performed using a context monitoring and matching module 440. For example, if conditions 410 are found to match the application context 405, a set of forms predicated by the conditions 410 (in this case, form 420 may be prompted to the user (e.g., the VIP) proactively to collect context sensitive inputs. The conditional form selection table 415 may be provided to application (e.g., game) developers or external application service administrators to optimize and/or provision types of forms that are appropriate for the specified context.

Such types of conditions may include where the user starts or ends of a game, a quest, or a specific resource gathering action; where the user idles for more than 5 minutes (or configured amount of time); where the user has difficulties passing a level; or where the user's performance has reduced to a level below the average players or the user's previous performance history. Such forms may include one or more of the following types of fields: Preference; Impression; or Complaints.

Preference fields may include options for indicating a preference for better shooting accuracy; more protection or energy; better players with similar skill set; more players with greater experience level in the game; faster elevation to the next level; more quests; more encounters; more resources; more actions; easier ways to find players of similar behavior; easier ways to share playing records with friends; fewer advertisements; or more relevant content feeds.

Impression fields may include options for indicating that the user feels that, for example, the theme is too long or too short; that there is not enough treasure or that there are too many options; that the play is interesting; that the quest is interesting or ordinary; or that the game is boring or too difficult.

Complaint fields may include options for indicating, for example, disconnections or lag; low image quality; that the play is too difficult or too easy; or that the pace is too slow.

The conditional form selection table 415 may support the selection of forms that match the context of the game (e.g., the play time for the game level, entering a new theme, completing a quest, purchased a resource, and so forth). By carefully provisioning the forms in the table, developers or administrators may minimize disruption and maximize user/player retention.

The conditions associated with the form inputs may be stored, for example in data store 425, and may be used for user behavior analysis, for example by analysis module 430. Remedial actions 435 may be issued to the user based on results of the analysis, possibly immediately or in real-time. In the case of complaints, the system may verify the user complaints and analyze the number of similar complaints in historical data based on context. Preferential treatment may be provided for VIPs using a rule engine. The preferential treatment may be issued to the user with prompts in real-time as remedial actions 435.

The condition detection, form selection, form display, user inputs, user data analysis, and remedial actions steps may iterate synchronously or seamlessly with the application or game actions context. This may have the advantage of enabling a VIP to experience personalized service and may enable developers to situate iterations at a point of the game that may not compromise the VIPs' gaming experience or performance.

The function modules and real-time process flow for collecting the VIP impression, preferences and complaints and providing remedial actions “at the moment of engagement” in the game, may have the advantage of improving a VIP's gaming experience in real-time. For example, if a VIP complains that the current level of the game is slow, then system 400 check for network impairments or whether the game server is overloaded; provide an error message regarding the network impairment experienced by other users or by the ISP; suggest the VIP to move to another game server; and/or provide credits for VIP to upgrade the network service.

Remedial action prompts 435 may include optional free, discount, or paid content feeds. This content, along with content descriptors, may be stored in a content descriptor and/or delivery portal 445. The contents may be selected based on the best match of content descriptor with the application context, such as the background theme of the game or quest. The content may be consumed while the game is playing or in separate window. The analytic and/or remedial action rule engines 430, 440 may interact with the content descriptor and/or delivery portal 445 to perform theme feature extraction, to perform content matching with content descriptor, and/or to initiate content feeds. The matched contents may be ranked and/or queued for a user to select what to display. The content display window may be blended inside the app or game window or may be run in a separate window.

The ranking of most suitable contents may be based on distance calculated between the multi-dimensional descriptors which may be extracted from the theme inside the game and/or descriptors of the contents. The descriptors may include semantics such as emotion type (e.g., sad, celebration, victory, and so forth) and background themes (e.g., runway, battle field, club, and so forth). Matched contents may be blended into the emotion and/or theme of the app (e.g., game) which may result in less disruption to the user and may result in higher probability of in-game purchase. The content delivery may be controlled by a service agreement and may be metered based on an amount of time the content is viewed. The types of contents may include extended trailers or full movies for example, which may create different levels of differentiated treatment corresponding to VIP level.

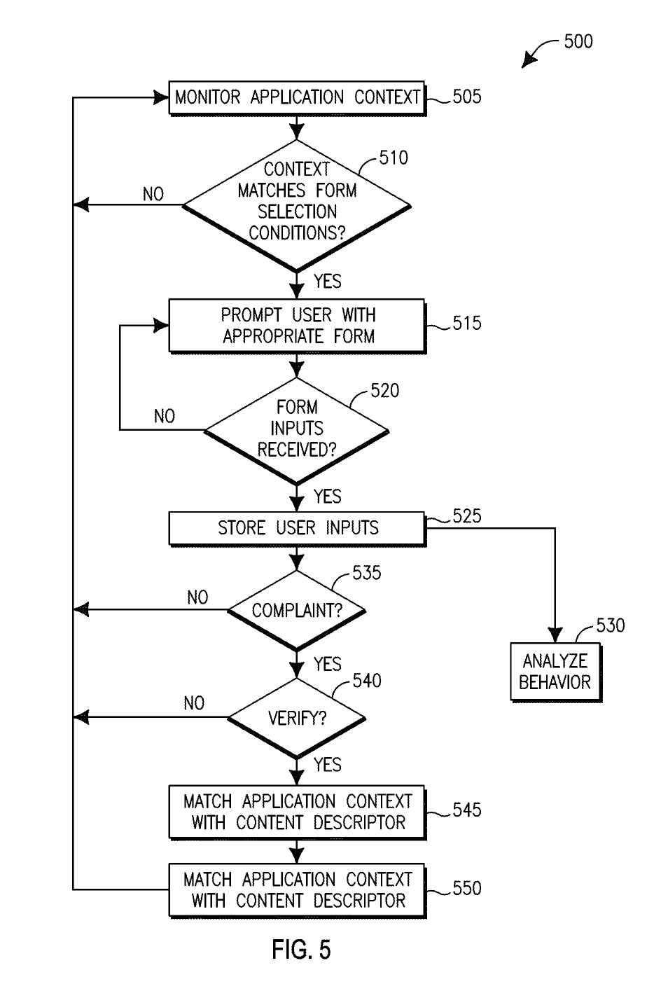

FIG. 5 is a flow chart 500 illustrating example operation of system 400. In step 505, application context is monitored to detect matches with conditions in a form selection table. If the application context matches conditions in the form selection table in step 510, the user is prompted with an appropriate form in step 515. If form inputs are received from the user in step 520, they may be stored in step 525 and may be used for behavior analysis in step 530. If the form inputs are determined to include a complaint in step 535, and are verified in step 540, the application context may be matched with a context descriptor associated with a remedial measure in step 545. A remedial measure corresponding to the matched context descriptor may be delivered to the user in step 550.

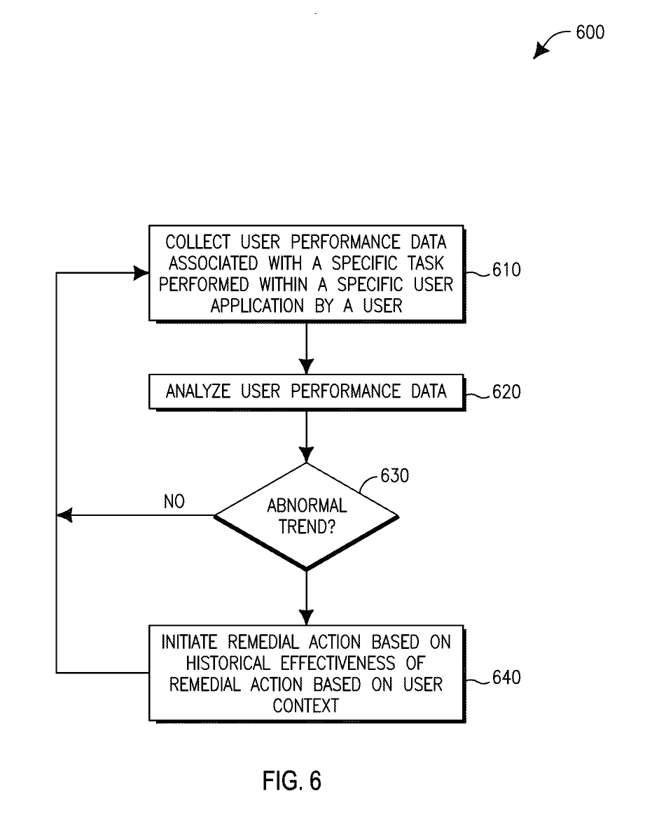

FIG. 6 is a flow chart 600 illustrating an example method according to aspects of the invention. The method of flow chart 600 may be implemented using any suitable mechanism, including for example those shown and described with respect to FIGS. 1A-C, 2, or 4, and may be incorporated or otherwise used with any suitable method including those shown and described with respect to FIGS. 3 and 5-6.

User performance data associated with a specific task, performed by a user within a specific user application may be collected in step 610. The user performance data may be analyzed in step 620. If an abnormal trend in the user performance data is detected in step 630, a remedial action may be initiated in step 640. The remedial action may be based on a historical effectiveness of the remedial action for that user, user context, and/or application context.

Although features and elements are described above in particular combinations, one of ordinary skill in the art may appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for managing user experience comprising:
collecting user performance data associated with a specific task performed by a user within an application;
analyzing the user performance data to determine whether an abnormal trend in user performance exists; and
on a condition that an abnormal trend in user performance exists, analyzing network quality of service (QoS) data to determine a network QoS parameter, and initiating a remedial action based on the abnormal trend in user performance and the network QoS parameter.

2. The method of claim 1, wherein the user performance data comprises user interface performance data, or application performance data.

3. The method of claim 1, wherein the remedial action comprises a network remedy on a condition that the network QoS parameter indicates network delays; and wherein the remedial action comprises a different remedy on a condition that the network QoS parameter does not indicate network delays.

4. The method of claim 1, wherein network QoS data is not analyzed on a condition that the abnormal trend does not exist.

5. The method of claim 1, wherein the remedial action comprises a customer retention action.

6. The method of claim 1, wherein the remedial action comprises providing the user with an increased level of network service on a condition that the network QoS parameter indicates network delays.

7. The method of claim 1, wherein the remedial action comprises providing the user with a postponed deadline or an increased number of allowable attempts on a condition that the network QoS parameter does not include network delays.

8. The method of claim 1, wherein the user performance data comprises a win rate.

9. The method of claim 1, wherein the user performance data comprises a duration of play.

10. The method of claim 1, wherein the user performance data comprises a quit time.

11. A computing device for managing user experience comprising:
a processor;
a memory; and
an interface for communication over a communications network;
wherein the processor is operable to:
collect user performance data associated with a specific task performed by a user within an application;
analyze the user performance data to determine whether an abnormal trend in user performance exists; and
on a condition that an abnormal trend in user performance exists, analyze network quality of service (QoS) data to determine a network QoS parameter, and initiate a remedial action based on the abnormal trend in user performance and the network QoS parameter.

12. The computing device of claim 11, wherein the user performance data comprises user interface performance data, or application performance data.

13. The computing device of claim 11, wherein the remedial action comprises a network remedy on a condition that the network QoS parameter indicates network delays; and wherein the remedial action comprises a different remedy on a condition that the network QoS parameter does not indicate network delays.

14. The computing device of claim 11, wherein network QoS data is not analyzed on a condition that the abnormal trend does not exist.

15. The computing device of claim 11, wherein the remedial action comprises a customer retention action.

16. The computing device of claim 11, wherein the remedial action comprises providing the user with an increased level of network service on a condition that the network QoS parameter indicates network delays.

17. The computing device of claim 11, wherein the remedial action comprises providing the user with a postponed deadline or an increased number of allowable attempts on a condition that the network QoS parameter does not indicate network delays.

18. The computing device of claim 11, wherein the user performance data comprises a win rate.

19. The computing device of claim 11, wherein the user performance data comprises a duration of play.

20. The computing device of claim 11, wherein the user performance data comprises a quit time.

21. A computer readable medium having instructions stored thereon which when executed by a processor of a computing device cause the computing device to
collect user performance data associated with a specific task performed by a user within an application;
analyze the user performance data to determine whether an abnormal trend in user performance exists; and
on a condition that an abnormal trend in user performance exists, analyze network quality of service (QoS) data to determine a network QoS parameter, and initiate a remedial action based on the abnormal trend in user performance and the network QoS parameter.
